(19) United States
(12) Patent Application Publication
(10) Pub. No.: US 2025/0046487 A1
(43) Pub. Date: Feb. 6, 2025

(54) HIGH POWER CONVERTER TARGET ASSEMBLY, RELATED FACILITY AND METHOD TO PRODUCE BREMSSTRAHLUNG FOR PHOTONUCLEAR REACTIONS

(71) Applicants: UNIVERSITÄT BERN, Bern (CH); EIDGENÖSSISCHES INSTITUT FÜR METROLOGIE METAS, Wabern (CH)

(72) Inventors: Andreas TÜRLER, Bern (CH); Mehran VAGHEIAN, Bern (CH); Matthias LÜTHI, Herrenschwanden (CH)

(73) Assignees: UNIVERSITÄT BERN, Bern (CH); EIDGENÖSSISCHES INSTITUT FÜR METROLOGIE METAS, Wabern (CH)

(21) Appl. No.: 18/717,401

(22) PCT Filed: Dec. 5, 2022
(86) PCT No.: PCT/EP2022/084449

§ 371 Date: Jun. 6, 2024

(30) Foreign Application Priority Data
Dec. 6, 2021 (EP) 21212627.0

(51) Int. Cl. G21G 1/10; H05H 6/00

(52) U.S. Cl. CPC G21G 1/10; H05H 6/00; H05H 2006/002; H05H 2242/10; H05H 2277/10

(57) ABSTRACT

A facility for the production of radionuclides based photonuclear irradiation, comprising: an electron accelerator (1), producing an electron beam (2); a converter target assembly (21) with a converter target (20) that converts the electron beam (2) to Bremsstrahlung photons (15); a production target (17), irradiated by the Bremsstrahlung photons (15) and thereby producing said radionuclides.

### FIELD

This disclosure relates to a facility for the production of radionuclides, in particular diagnostic and therapeutic radionuclides, based on the principle of photonuclear irradiation. This disclosure also relates to a converter target assembly for usage in such a facility. This disclosure further relates to a method of operating such a facility and to a method of producing radionuclides.

### BACKGROUND

Photonuclear reactions have been identified as very suitable for the production of diagnostic and therapeutic radionuclides for applications in nuclear medicine. With high energy photons (>8 MeV) nuclear reactions of the type (γ,n), (γ, 2n), (γ,p), and (γ, pn) can be induced. Photonuclear reactions show significant cross section in the giant dipole resonance (GDR) region, which, in certain cases are not significantly smaller than for charged particle induced reactions (such as protons, deuterons, ³He and ⁴He). Due to the penetrating properties of high energy photons compared to charged particles, the overall production yield of radionuclides with high energy photons can be very high since the missing cross section compared to charged particle reactions can be overcompensated by much thicker targets. In general, the photonuclear reaction cross sections scale roughly with atomic number.

Promising candidates of radionuclides that are high in demand and can be produced using photonuclear reactions are ⁹⁹Mo (for ⁹⁹Mo/^{99m}Tc radionuclide generators) produced in a ¹⁰⁰Mo(γ,n) reaction or the positron emitter ⁶⁴Cu for positron emission tomography, produced in a ⁶⁶Zn(γ,np) reaction. Furthermore, significant activities of ¹¹¹In can be produced in the photonuclear reaction ¹¹²Sn(γ,n)¹¹¹Sn [symbol] ¹¹¹In.

Promising candidates of radionuclides used for radionuclide therapy which are presently not easily available, but which are high in demand can be produced in high yields are the alpha-particle emitter ²²⁵Ac (from decay of ²²⁵Ra that is formed in the photonuclear reaction ²²⁶Ra(γ,n)), the beta-minus emitters ⁶⁷Cu (produced in the reaction ⁶⁸Zn(γ,p)) and ⁴⁷Sc (produced in the reaction ⁴⁸Ti(γ,p)). Furthermore, the beta-minus emitter ¹⁴⁹ Pm with 53.1 h half-life produced in the photonuclear reaction ¹⁵⁰Nd(γ,n)) has promising chemical and decay properties as therapeutic radionuclide. Also, the commonly used beat-minus emitter ⁹⁰Y or ¹⁷⁷Lu can be produced in a ⁹¹Zr(γ,p) or a ¹⁷⁸Hf(γ,p) reaction, respectively.

### BRIEF SUMMARY

The objective underlying the present disclosure is to provide a facility that allows for an industrial-scale production of rare but highly demanded radionuclides, in particular diagnostic and therapeutic radionuclides, such as, for example, ²²⁵Ac or ⁹⁹Mo. The facility shall be cost-efficient to erect and operate, with high reliability, high safety margins, and minimal consumption of raw materials during operation. Furthermore, a converter target assembly for usage in such a facility shall be provided. Corresponding methods of operation and for the production of radionuclides shall be given as well.

According to this disclosure, the first-mentioned objective is met by a facility according to example 1.

This disclosure provides a facility for the production of radionuclides, in particular diagnostic and therapeutic radionuclides, based on the principle of photonuclear irradiation, comprising
an electron accelerator, producing an electron beam, and, if necessary, a beam transfer line,
a converter target assembly with a converter target that converts the electron beam to Bremsstrahlung photons,
a number of production targets, irradiated by the Bremsstrahlung photons and thereby producing said radionuclides,
   wherein the converter target assembly comprises a sealed housing, the housing
enclosing a cavity which holds the converter target,
comprising an entry window for the electron beam and an exit window for the Bremsstrahlung photons,
comprising cooling medium ports, these ports being part of a cooling circuit for establishing a cooling flow through the cavity, thereby cooling the converter target and the entry window,
   wherein
the converter target comprises a number of rotatable converter disks,
the electron beam is set off-center with respect to the respective converter disk, and wherein the respective converter disk is designed to rotate during operation of the facility, thereby, in the course of time, spreading or distributing the focal spot of the electron beam over an annular area of the converter disk.

This disclosure is based on the consideration that a high yield of radionuclides of the kind mentioned above can be produced according to the principle of photonuclear irradiation if an electron beam with relatively high electron energy and high beam power is directed onto a suitable point-source, high-power converter target to produce Bremsstrahlung, which is then used to irradiate a suitable production target. One key element to enable the converter target to withstand the heat-load associated with such a high-intensity electron beam while at the same time maintaining a point-source characteristic of the emerging photon radiation, is to distribute the beam energy over a relatively large area of the converter target by rotating a number of stacked converter disks during irradiation, and at the same time to remove excess heat by a flow of cooling medium, in particular a cooling gas, being in direct contact with the surface of the converter disks. The impact or focal point of the electron beam is essentially fixed in space—albeit some small (as compared to the target size) wobbling may be allowed or even forced—while the respective converter disk moves relative to this fixed point.

The other mentioned objectives are met by a converter target assembly according to claim 22 and by corresponding methods defined in claim 24 et seq.

Further features, embodiments, objectives, and related advantages are associated with the co-pending independent and the dependent claims and the corresponding description in connection with the accompanying drawings.

In view of the foregoing and subsequent description, the following non-limiting examples are contemplated, many of which are considered inventive in their own right.

1. Facility for the production of radionuclides, in particular diagnostic and therapeutic radionuclides, based on the principle of photonuclear irradiation, comprising
an electron accelerator (1), producing an electron beam (2), and, if necessary, a beam transfer line (3),
a converter target assembly (21) with a converter target (20) that converts the electron beam (2) to Bremsstrahlung photons (15),
a production target (17), irradiated by the Bremsstrahlung photons (15) and thereby producing said radionuclides,
   wherein the converter target assembly (21) comprises a sealed housing (9), the housing (9)
enclosing a cavity (19) which holds the converter target (20),
comprising an entry window holder (8) with a mounted window disk (23) for the electron beam (2) and an exit window (22) for the Bremsstrahlung photons (15),
comprising cooling medium ports (10), these ports being part of a cooling circuit (11) for establishing a cooling flow through the cavity (19), thereby cooling the converter target (20) and the entry window holder (8) with its mounted window disk (23),
   wherein
the converter target (20) comprises a number of rotatable converter disks (12),
the electron beam (2) is set off-center with respect to the respective converter disk (12),
   and wherein the respective converter disk (12) is designed to rotate during operation of the facility, thereby, in the course of time, spreading the focal spot of the electron beam (2) over an annular area of the converter disk (12).

2. Facility according to example 1, wherein the electron accelerator (1) is designed to generate electron energies in excess of 20 MeV.

3. Facility according to example 1 or 2, wherein the electron accelerator (1) is designed to generate beam powers in excess of 20 kW.

4. Facility according to any of the preceding examples, wherein the electron accelerator (1) generates a pulsed or a continuous wave electron beam (2).

5. Facility according to example 4, wherein the pulsed electron beam (2) has impulse times and period times in the range of milliseconds or longer.

6. Facility according to example 4 or 5, wherein the electron accelerator (1) is a rhodotron.

A rhodotron is an electron accelerators based on the principle of re-circulating a beam through successive diameters of a single coaxial cavity resonating in metric waves. After one acceleration phase the beam is redirected by means of magnets back to the cavity. The emerging pattern resembles the arrangement of petals of a rose flower (from the Greek ‘rhodon’ for rose, because of the rosette-like particle path).

7. Facility according to example 4 to 5, wherein the electron accelerator (1) is a superconducting linear accelerator.

8. Facility according to any of examples 4 to 7, comprising a control unit (24) which keeps the rotation speed of the respective converter disk (12) synchronized with the time structure of the electron beam pulses.

The control unit preferably comprises suitable sensors, actors, and controllers for this task.

For example, the rotation speed of a Tesla turbine (see below) can be controlled by controlling the pressure difference between the tangential input nozzles and the outflow, thereby controlling the gas velocity interacting with the converter disks.

9. Facility according to example 8, wherein the area on the respective converter disk (12) exposed to a single beam pulse describes a complete ring (14) or sectors thereof, wherein the ratio of the revolution time of the converter disk (12) to the beam pulse time is preferably chosen such that all sectors are irradiated homogeneously over multiple irradiation cycles.

10. Facility according to example 8 or 9, wherein the rotation speed of the respective converter disk (12) is set in the range from a few thousands to several ten thousands of revolutions per minute.

Ideally, one beam pulse interval is mapped to one full revolution, but in practice the maximum rotational velocity may be limited by the stress- or burst resistance of the converter disk material under high centrifugal force.

11. Facility according to any of the preceding claims, wherein the entry window holder (8) comprises a rotatable window disk (23), the electron beam (2) is set off-center with respect to the window disk (23), and wherein the window disk (23) is designed to rotate during operation of the facility, thereby, in the course of time, spreading the focal spot of the electron beam (2) over an annular area of the window disk (23).

This is another key embodiment of the invention, allowing for efficient heat distribution over a larger area of the entry window, analogously to the converter disks.

The window disk (23) is preferably mounted in/on/at a hollow shaft (30). The rotation of the hollow shaft (30) is preferably facilitated by a rotary drive (26).

12. Facility according to example 11, wherein the entry window holder (8) is coupled to a rotary drive (26).

The rotary drive could be a stepping motor mounted outside of the housing, whereby the hollow magnetofluid sealed vacuum feedthrough is driven by a gear drive.

13. Facility according to example 11 or 12, wherein the entry window holder (8) comprises a window disk (23), which is a Beryllium foil or any other high strength material of low atomic number.

14. Facility according to any of examples 11 to 13, wherein the entry window holder (8) is mounted on/in/at a hollow shaft, which is part of a rotary vacuum feedthrough.

15 Facility according to example 14, wherein the entry window holder (8) and the mounted window disk (23) is sealed with respect to the beam transfer line (3) by a magnetofluid sealing.

Due to the required thin thickness of the entry vacuum window and the mechanical and thermal stress it is exposed to, a preferred diameter of 40 mm was considered. Commercially available hollow shaft magnetofluid sealed vacuum feedthroughs allow for maximum rotation speeds of 3,100 rpm. Provisions on the hollow shaft to drive it with a gear drive are commercially available.

16. Facility according to any of examples 11 to 15, wherein a control unit (25) keeps the rotation speed of the entry window holder (8) and the mounted window disk (23) synchronized with the time structure of the electron beam pulses.

17. Facility according to example 16, wherein the area on the window disk (23) exposed to a single beam pulse describes a complete ring or sectors thereof, wherein the ratio of the revolution time of the window disk (23) to the beam pulse time is preferably chosen such that all sectors are irradiated homogeneously over multiple irradiation cycles.

18. Facility according to example 16 or 17, wherein the rotation speed of the window disk (23) is set in the range from several hundreds to several thousands of revolutions per minute.

In theory, the window disk might rotate as fast as the converter disks, ideally mapping one beam pulse interval to one full revolution, but in practice the currently available vacuum feedthroughs limit the maximum rotational velocity.

19. Facility according to any of the preceding examples, wherein the beam transfer line (3) comprises an optical element (5a-c) that allows for focusing or defocusing of the electron beam (2) to different FWHM.

20. Facility according to example 19, wherein a FWHM of at least 2 mm is set.

21. Facility according to any of the preceding examples, wherein the beam transfer line (3) comprises a beam wobbler (6, 7) that allows for periodical movement of the focal spot of the electron beam (2) on the entry window foil (23) and on the respective converter disk(s) (12).

22. Facility according to example 21, wherein the wobble amplitude is in the range of millimeters on the converter disk(s) (12).

23. Facility according to example 21 or 22, wherein the wobble frequency is in the range of 10¹ to 10⁶ Hz.

24. Facility according to any of the preceding examples, wherein the beam transfer line (3) comprises a slammer valve (4) triggered by a downstream pressure sensor in order to protect the electron accelerator (1) from a vacuum breach in the converter target assembly (21).

25. Facility according to any of the preceding examples, wherein the converter target (20) comprises a plurality of converter disks (12), in particular 4 converter disks (12).

26. Facility according to example 25 wherein the converter disks (12) are stacked on a common shaft (13).

Preferably, the converter disks are stacked or placed one after another (concentrically) on the shaft with gaps in between them, to allow a flow of cooling medium to cool any of the disks from both sides. On the other hand, the gaps are small enough in order to keep the converter target compact and not to destroy the essential point-source characteristic of the emerging photon radiation.

27. Facility according to example 25, wherein the converter disks (12) are arranged in a row one after the other, but on parallel shafts, such that the converter disks (12) partially overlap when viewed in the direction of the shafts.

28. Facility according to example 26 or 27, wherein each shaft (13) is aligned in parallel to the direction of the electron beam (2).

29. Facility according to any of the preceding examples, wherein the respective converter disk (12) is coupled to a rotary drive (27).

The rotary drive is preferably mounted outside of the housing in a shielded position. The converter disks are preferably driven by a stepping motor via a gear drive and a rotary feed through.

30. Facility according to any of the preceding examples, wherein the converter disks (12) are arranged to form a Tesla pump.

31. Facility according to any of the preceding examples, wherein the converter disks (12) are designed to be driven by the cooling flow.

This in general means some sort of turbine configuration. For example, a converter disk may be coupled to an axial or radial turbine placed in the cooling flow.

32. Facility according to example 31, wherein the converter disks (12) are arranged to form a Tesla turbine.

This way, essentially the respective converter disk itself forms a turbine.

The Tesla turbine is a bladeless centripetal flow turbine patented by Nikola Tesla in 1913. It is referred to as a bladeless turbine.

The Tesla turbine is also known as a boundary-layer turbine, cohesion-type turbine, or Prandtl-layer turbine (after Ludwig Prandtl) because it uses the boundary-layer effect and not a fluid impinging upon the blades as in a conventional turbine.

A Tesla turbine comprises a set of smooth disks, with nozzles applying a moving fluid to the edge of the disk. The fluid drags on the disk by means of viscosity and the adhesion of the surface layer of the fluid. As the fluid slows and adds energy to the disks, it spirals into the center exhaust. Since the rotor has no projections, it is very sturdy. A very high rotational speed up to several tens of thousands revolutions per minute can be reached.

33. Facility according to example 31 to 32, wherein the rotation speed of the converter disks (12) is controlled by the tangential flow velocity of the cooling flow using a differential pressure regulator.

34. Facility according to any of the preceding examples, wherein the converter disks (12) are predominantly made of Tantalum or Tungsten.

35. Facility according to any of the preceding examples, wherein the respective converter disk (12) has a number of radially aligned slots or indentations at its outer circumference.

36. Facility according to any of the preceding examples, wherein the exit window comprises a flattening filter (22) that absorbs most of the photons with photon energy ≤8 MeV and preferably absorbs and/or slows down residual electrons.

37. Facility according to example 36, wherein the flattening filter (22) comprises a water-cooled Aluminum column.

38. Facility according to any of the preceding examples, wherein the exit window comprising a flattening filter (22) comprises a neutron absorber (16).

39. Facility according to any of the preceding examples, wherein the cooling medium is a cooling gas.

40. Facility according to example 39, wherein the cooling gas is Helium.

41. Facility according to any of the preceding examples, wherein a massive and preferably water-cooled beam stop (18) is arranged behind the production target (17).

Besides the production of radionuclides, the invention also relates to a method of operating such a facility for usage in producing photoneutrons as an electron accelerator-based neutron source. The produced photoneutrons can find a variety of applications in different fields of science and engineering, such as materials characterization, nuclear science, neutron radiography, and offer a number of advantages over reactor-based neutron sources, including the problem of managing radioactive wastes. A high yield of photoneutrons can be produced according to the principle of photonuclear irradiation if an electron beam with relatively high electron energy and high beam power is directed onto a suitable point-source, high-power electron-photon converter target (the first converter target) to produce Bremsstrahlung, and is then used to irradiate a suitable element (the second converter target), such as one (or more) thick beryllium target(s) (through the ⁹Be(γ,n)⁸Be reaction) as the photon-neutron converter target. Therefore, this disclosure provides a facility for the production of high yield photoneutrons using two (or more) types of converter target materials in a new innovative converter target assembly set-up, based on the principle of photonuclear reactions.

42. Facility according to any of the preceding examples, wherein the region of origin of the emerging Bremsstrahlung photons, apart from some optional wobbling with an amplitude in the range of millimeters, is fixed in space.

43. Facility according to any of the preceding examples, wherein the production target (17) is predominantly made of one of the following isotopes: ²²⁶Ra, ¹⁷⁸Hf, ¹⁵⁰Nd, ¹¹²Sn, ¹⁰⁰Mo, ⁹¹Zr, ⁶⁶Zn, ⁶⁸Zn, ⁴⁸Ti, ⁴⁸Ca.

44. Converter target assembly (21) for a facility according to any of the preceding claims, comprising a sealed housing (9), the housing (9)
enclosing a cavity (19) which holds the converter target (20),
comprising an entry window holder (8) with a mounted entry window disk (23) for an electron beam (2) and an exit window (22) for Bremsstrahlung photons,
comprising cooling medium ports (10), these ports being designated to be connected to a cooling circuit (11) for establishing a cooling flow through the cavity (19), thereby cooling the converter target (20) and the entry window holder (8) with its mounted entry window disk (23),
   wherein the converter target (20) comprises a number of rotatable converter disks (12), and wherein the respective converter disk (12) is designed to rotate during operation of the facility, thereby, in the course of time, spreading the focal spot of an incoming electron beam (2) over an annular area of the converter disk (12).

45. Converter target assembly (21) according to example 44, wherein the entry window holder (8) comprises a rotatable window disk (23), wherein the window disk (23) is designed to rotate during operation of the facility, thereby, in the course of time, spreading the focal spot of an incoming electron beam (2) over an annular area of the window disk (23).

46. Method of operating a facility according to any of the preceding examples, wherein at least of the following radionuclides is produced: ²²⁵Ra, ²²⁴Ra, ²²⁵Ac, ²¹³Bi, ²¹²Pb, ¹⁷⁷Lu, ¹⁴⁹Nd, ¹⁴⁹Pm, ¹¹¹Sn, ¹¹¹In, ⁹⁰Y, ⁹⁹Mo, ⁶⁷Cu, ⁶⁴Cu, ⁴⁷Ca, ⁴⁷Sc.

47. Method of producing radionuclides, wherein an electron beam (2) is directed onto a converter target (20) with a number of rotating converter disks (12), such that, in the course of time, the focal spot of the electron beam (2) is spread over an annular area of the respective converter disk (12), thereby producing a beam of Bremsstrahlung photons for irradiation of a production target (17), wherein the converter target (20) is cooled by a flow of cooling medium, in particular gaseous Helium.

48. Method according to example 47, wherein the converter target (20) is arranged inside a housing (9), and wherein the electron beam (2) is lead through a rotating entry window holder (8) with a mounted entry window disk (23) of the housing (9), such that, in the course of time, the focal spot of the electron beam (2) is spread over an annular area of the entry window disk (23).

### BRIEF DESCRIPTION OF THE DRAWINGS

A detailed description of the invention is subsequently set out with respect to the accompanying drawings.

FIG. 1 shows schematically an assembly of a photonuclear irradiation set-up.

FIG. 2 shows a schematic of a rotating hollow shaft vacuum feedthrough with magnetofluid sealing. The vacuum window disk is mounted on the upstream side of the rotating shaft. The beam axis is off-center to the rotation axis.

FIG. 3 shows an exemplary illustration of angular beam patterns on a rotating disk.

FIG. 4 shows a comparison between the time structures of electron beams produced by a linear accelerator (2.4 mA) and a rhodotron (3.125 mA) with similar beam power.

FIG. 5 shows the effect of the energy deposition on a, e.g. Beryllium (Be), vacuum foil as a function of full width at half maximum (FWHM) of the beam.

FIG. 6 shows the effect of the energy deposition on a, e.g. Beryllium (Be), vacuum window foil mounted on/in a hollow shaft of a rotary vacuum feedthrough.

FIG. 7 shows a proposed scheme of irradiation of a rotating, e.g. Beryllium (Be), vacuum window foil.

FIG. 8 shows maximum temperatures reached when a beam of electrons of 40 MeV with a beam power of 125 kW passes through a rotating vacuum window assembly in dependence of the thickness of the foil and the FWHM of the beam.

FIG. 9 shows a deposition pattern of a wobbled electron beam on a moving surface.

FIG. 10 shows a schematic of the distribution of beam pulses on a rotating disk, e.g. a tantalum disk of 1.125 mm thickness.

FIG. 11 shows maximum temperatures reached by passage of a beam of 40 MeV electrons and 125 kW beam power through a 1.125 mm thick converter disk rotated at 24,000 rpm and cooled by rapidly flowing helium gas.

FIG. 12 shows an illustration of a rotating disk converter design of a Tesla turbine/pump type.

FIG. 13 shows an arrangement of four partially overlapping disks as converter targets. The left section provides a perspective view. In the right section a view in electron beam direction is given.

FIGS. 14a and 14b show various disk arrangements to be employed in connection with FIG. 13.

FIG. 15 shows an example of a slotted disk to avoid warping due to heavy heat load.

FIG. 16 shows the position of a water-cooled aluminum column which serves as exit window and flattening filter to prevent the irradiation of the sample targets with electrons and low energy photons. Also shown is the possibility to irradiate multiple production targets simultaneously with the same photon beam.

Table 1 shows the calculated energy deposition of a 40 MeV electron beam with 125 kW beam power in a point source converter assembly. For the calculation, the assumed Tantalum (Ta) converter was subdivided in 4 sections of 1.125 mm thickness each for better cooling.

### DETAILED DESCRIPTION

According to this disclosure, key to the industrial implementation of photonuclear reactions for medical radionuclide production are the following components:
1.) A high-power electron accelerator with available electron energies in excess of about MeV and beam powers in excess of about 20 kW.
2.) A high-power converter target that converts the electron beam to Bremsstrahlung (braking radiation) photons that can absorb the power delivered by the high intensity electron beam. The higher the photon flux in the GDR region, the higher the specific activity that can be reached (i.e. for ⁹⁹Mo production), or the less target material for production targets must be employed, which mostly are valuable isotopically enriched materials (i.e. ⁶⁸Zn for ⁶⁷Cu production) or hazardous, highly radioactive materials (i.e. ²²⁶Ra).
3.) Production target designs that can withstand the high energy, high intensity photon flux while at the mean time safely encapsulating hazardous and/or radioactive target materials (i.e. ²²⁶Ra).
4.) Automated chemical procedures to extract the desired radionuclides in quality and quantity suitable for medical applications.

Ad 1): Several designs of electron accelerators have been developed in the past mainly for generating Bremsstrahlung up to 10 MeV for the sterilization of medical equipment or curing of polymers. Currently, accelerators with 30-40 MeV beam energy and beam powers of 100 kW or more are commercially available.

Ad 2): No high-power, point source converter targets have been developed that could convert electron beams in excess of 20 MeV and in excess of 100 kW beam power to Bremsstrahlung. This fact has effectively prevented the use of photonuclear reactions for the large-scale production of medical radionuclides. The description of such a converter target is the main the topic of the current application.

Ad 3): As target materials can be encapsulated in relatively thick, high strength and high temperature materials, existing methods can be adapted to the task.

Ad 4): For many of the above-mentioned radionuclides, chemical separation procedures to separate the desired product from the target material have already been developed or can be adapted from existing procedures.

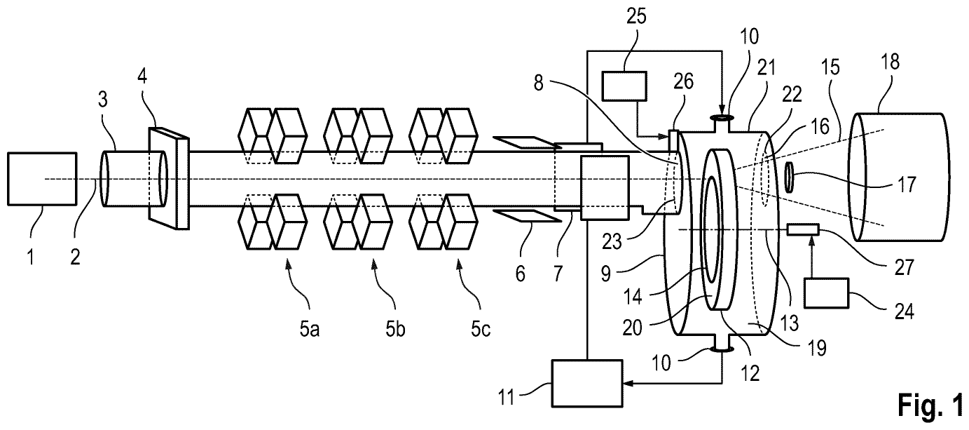

Based on the above presented assessment, the design and construction of a high-power converter target to produce Bremsstrahlung for photonuclear reactions is essential. Essential and preferred components, their function and their technical realization are sketched in the accompanying FIG. 1 and described below.

FIG. 1 schematically shows a preferred assembly of a photonuclear irradiation set-up comprising a high-power electron beam 2 provided by an electron accelerator 1, a vacuum beam line 3, a fast acting vacuum valve 4 (slammer valve) arranged within the beam line 3, a number of beam optical elements (5a-c) for focusing or defocusing the beam 2 to different full width at half maximum (FWHM), a beam wobbler comprising beam deflection units 6 and 7, a rotating vacuum window holder 8 comprising a rotatable vacuum window disk 23, a rotary drive 26 for the vacuum window with associated control unit 25, a housing 9 for a rotating converter target 20, provisions, i.e. inlet and outlet ports 10 for providing a cooling medium flowing through the housing 9, and a converter target 20 with a number of (shown here: one) rotating converter disks 12 enclosed by the housing 9. Further indicated are a distributed beam spot 14 (trace over time) on the rotating converter disk(s) 12, the rotation axis 13 of the converter disk(s) 12 coupled to a rotary drive 27 with associated control unit 24, an emerging cone 15 of Bremsstrahlung photons, a flattening filter and neutron absorber 16, production target(s) 17, and a massive high-density beam stop 18.

As will be apparent from FIG. 1 and from the detailed description below, the vacuum window holder 8 with its mounted vacuum window disk 23 arranged in the housing 9 acts as an inlet or entry window for the electron beam 2, entering a cavity 19 enclosed by the housing 9. The electron beam 2 impinges on the converter target 20 located in the cavity 19 and generates Bremsstrahlung photons 15. The flattening filter 22 and neutron absorber 16 arranged in the housing 9 acts as outlet or exit window 22 for the photon cone 15 leaving the cavity on the other side. The photon cone 15 is centered around the prolongation of the electron beam axis. The cavity 19 is sealed by the housing 9 in a gas-tight manner with respect to the outer environment. That is, the entry window 8 and the flattening filter exit window 22 provide a gas-tight barrier but are transparent for electron radiation or photon radiation, respectively. A flow of cooling medium, in particular cooling gas, within the cavity 19 provides cooling for the converter target 20—and also for the vacuum window holder 8 comprising a rotating vacuum window disk 23, by flowing over its inner surface inside the cavity 19. This cooling flow enters and leaves the cavity 19 through according cooling medium inlet and outlet ports 10 arranged in the housing wall. The housing wall may be further cooled by a flow of cooling liquid, in particular cooling water, through suitable channels.

The cooling flow through the cavity 19 is part of a cooling circuit 11, which is indicated only schematically in FIG. 1. Advantageously, gaseous Helium is used as a cooling medium. The pressure of the cooling gas in inside the cavity 19 is preferably in the range of atmospheric pressure in order to keep the differential pressure on the entry window 8 and the flattening filter exit window 22 in a manageable range. However, in the case of a Tesla turbine formed by the converter disks 12, which is explained further below, the cooling gas inlet port may comprise a nozzle, which is designed for a discharge pressure up to several bar, leading the cooling gas in a tangential manner to the outer circumference of the converter disks 12.

As will be appreciated in more detail below, the rotation axis 13 of the converter disks 12 is arranged off-center (parallelly shifted) with respect to the axis of the electron beam 2.

Furthermore, the entry window holder 8 for the electron beam 2 preferably comprises a rotatable window disk 23, the rotation axis of which is also arranged off-center (parallelly shifted) with respect to the axis of the electron beam 2.

The unit comprising the housing 9 with the cooling gas inlet port and outlet port 10, the vacuum window holder 8 with a mounted vacuum window disk 23 for the entry of the electron beam 2, the flattening filter 22 and neutron absorber 16 at the exit of the photon cone 15, and the integrated converter target 20—if necessary, with a related rotary drives for the vacuum window holder 8 comprising a vacuum window disk 23 and/or the converter target 20—may be called converter target unit or converter target assembly 21.

Instead of a single flattening filter 22 and neutron absorber 16, there may two (or more) separate filters, one for the purpose of flattening (see below), and one for the purpose of neutron absorption. While it is convenient that these functions are integrated into a single exit window 22 of the housing 9, there might be an exit window 22 for high-energy photons plus a number of additional filters of the kind described above, either integrated in one assembly or realized as separate components. For example, there may be a simple exit window 22, sealing the housing 9 in a gas-tight manner with respect to the outer environment, and then a flattening filter and a neutron absorber in arbitrary order (as viewed in the direction of the passing photons), or just one or even none of the latter.

More specifically, an industrial radionuclide production facility using photonuclear reactions preferably comprises:
A high-power electron accelerator.
An evacuated beam transfer line transporting the extracted electron beam in vacuum.
Preferably a fast-acting valve with a downstream pressure sensor (slammer valve) that protects the accelerator from a vacuum breach.
Preferably a beam optical element that allows focusing or defocusing of the beam to different FWHM, e.g. in the form of a quadrupole triplet.
Preferably, a beam optical element that allows a fast movement of the beam in x- and y-axis direction with high frequency, called a “beam wobbler”.
A vacuum window that separates the vacuum of the accelerator and beam line from the converter target assembly.
A housing containing the converter target assembly.
Provisions and connections for cooling gases and/or cooling liquids.
A cooled converter target assembly that (ideally fully) stops the electron beam and converts it to Bremsstrahlung photons of various energies. The converter target preferably comprises several disks, thereby reducing the individual thermal load and arranged in an optimal way for efficient cooling.
By rotating the converter disks, preferably synchronized with the beam structure of the beam, the incoming beam packets are distributed over a large area of the converter disks.
Preferably a flattening filter that absorbs most of the low energy photons that contribute only to heating of the production targets while not inducing photonuclear reactions.
Preferably a neutron filter for low energy and high energy photoneutrons that contribute to the production of undesired side products, thus enhancing radionuclidic purity of the desired products.
A cooled assembly holding at least one preferably a stack of multiple production targets, and preferably provisions to remotely add or retrieve production targets.
A cooled block of Beryllium (optional) for generating photoneutrons.
A cooled massive beam stop with auxiliary (optional) irradiation positions for gemstone coloration.
A cooling loop, in particular a gas cooling loop, preferably with pump, reservoir, heat exchangers and filters to cool the converter target assembly.

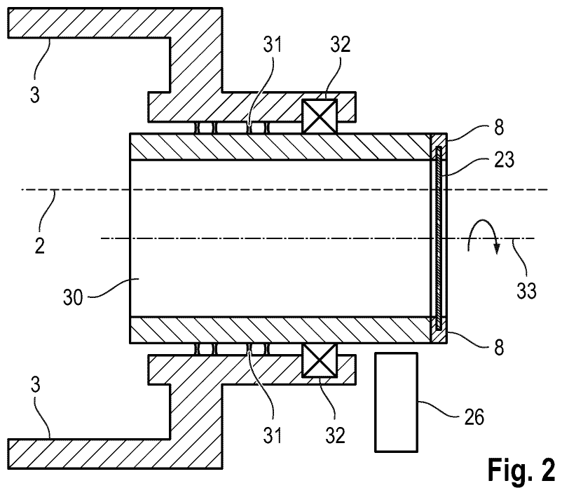

FIG. 2 shows schematically a rotating vacuum window assembly. The electron beam 2 is impinging on the Beryllium vacuum window disk 23 off-center. The Beryllium vacuum window disk is mounted in a ring-like holder 8 attached to a rotating hollow shaft 30 vacuum feedthrough 30. Alternatively, the holder 8 may be an integral part of the hollow shaft 3. On the left, the rotating vacuum window assembly is connected to the beam transfer line 3. On the right, there is the cavity 19. The hollow shaft 30 with its magnetofluidic seals 31 and bearings 32 separates the vacuum of the accelerator 1 and the beam transfer line 3 from the cooling gas atmosphere in the housing 9. The hollow shaft is driven by rotary drive 26 and a corresponding control unit 25 (as indicated schematically in FIG. 1).

In the accompanying Table 1 the energy deposition of a 40 MeV electron beam with 125 kW beam power using a beryllium vacuum window and a distributed 4 section Tantalum (Ta) converter and a water-cooled aluminum flattening filter has been calculated, in order to estimate the heat load of the individual components and the required cooling capacity.

In the following paragraphs preferred embodiments of the individual components and underlying concepts are described in more detail.

### 1) Synchronization of Rotating Vacuum Window and Converter Target to the Beam Structure

In the presented approach, the fixed beam spot is directed onto a rotating disk (vacuum window or converter target). To distribute the heat load on the disk, the revolution time of these components are synchronized to the beam structure. The beam time structure can be modeled using the beam impulse time t_{I}, which describes the beam on time, and the time span between two pulses, denoted as period time t_{P}. The duty factor D=t_{I}/t_{P} relates the two time spans and can vary between 0 and 1. The disk rotation can be described by a single parameter, the revolution time t_{R}, which corresponds to a revolution speed (in rad/s) ω=2π/t_{R}. The so described system is equivalent to a fixed disk and a rotating beam. Using polar coordinates (with a radial component r and an angular component φ) the temporal evolution of center of the beam spot path on the disk can be described using

$$φ ( t ) = δ ( t ) \frac{2 π}{{t}_{R}} t = ω t$$

$$r ( t ) = {r}_{0}$$

Where for simplicity the radial component is kept constant. The function δ(t) describes the beam modulation and takes the following form:

$$δ ( t ) = \{ \begin{matrix}1 for k \cdot {t}_{P} < t < k \cdot {t}_{P} + {t}_{I} & k ∈ ℕ \\ 0 & otherwise\end{matrix}$$

For illustrative purposes the start angle sₖ and the endpoint angle eₖ of an irradiated track path on the disk can be calculated for each discrete period k

$${s}_{k} = \frac{2 π}{{t}_{R}} k {t}_{P}$$

$${e}_{k} = \frac{2 π}{{t}_{R}} ( k {t}_{P} + {t}_{I} )$$

Using the fractions α=t_{I}/t_{R} and β=t_{P}/t_{R} the above equations can be made dimensionless

$${s}_{k} = 2 πβ$$

$${e}_{k} = 2 π ( k β + α ) .$$

Hence, the angle covered by the irradiated beam path is given by

$$Δ = {e}_{k} - {s}_{k} = 2 π α .$$

From this expression it becomes clear that the fraction α defines the number of segments on the disk if the revolution time is chosen as a multiple of the impulse time (e.g. for α=⅓, Δ=2π/3 so the disk is divided in three sectors). Furthermore, the distance between two subsequent start and end points can be written as

$$Δ s = {s}_{k + 1} - {s}_{k} = 2 πβ$$

$$Δ e = {e}_{k + 1} - {e}_{k} = 2 π β .$$

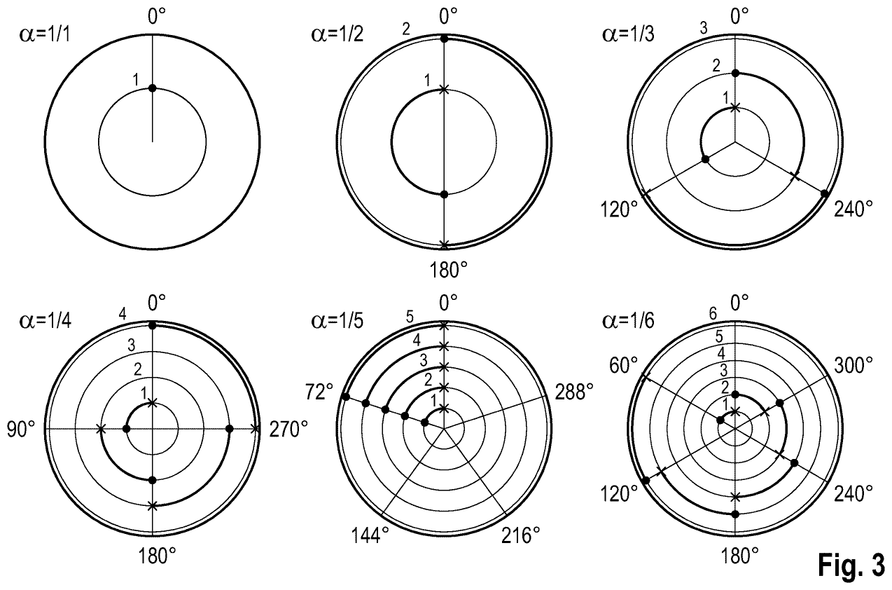

From these relations it becomes apparent that values β=1, 2, 3, . . . should be avoided. In these cases, the angle between two subsequent start points is one or more full rotations, hence the start point is always at the same position. This is only acceptable in the case of α=1 where only one sector on the disk exists anyway. Together with the relation β=α/D the above relations can be used to choose a revolution time for a given duty factor to optimize the irradiation pattern. As an example the irradiation patterns are depicted in FIG. 3 for a duty factor D=⅕ for various α.

More specifically, FIG. 3 shows an exemplary illustration of angular beam patterns on a rotating disk for a duty factor of ⅕ and various α. For illustrative purposes the radius of each subsequent irradiation path is incrementally increased. Crosses and dots indicate the start and endpoints, respectively. For each a the respective sectors are indicated as well.

### 2) Electron Beam Accelerators and Specifications

An electron accelerator suitable to induce photonuclear reactions has to fulfill a number of requirement concerning electron beam energy, beam intensity (beam power), time structure of the beam and width of the beam. Currently several types of accelerators are commercially available which are able to deliver electron beams with energies larger than 20 MeV and beam powers in excess of 20 kW, which are a prerequisite for a profitable radionuclide production for medical applications.

Linear accelerators with electron energies between 35 and more than 100 MeV and max. beam powers between 35 and 120 kW are commercially available. Peak current intensities of 200 to 300 mA are available at variable repetition rates up to 800 Hz resulting in average beam currents of up to 4 mA. The length of one pulse can be up to 16 ρs [1a]. The electron beam can be shaped to different full width at half maximum (FWHM) with the use of beam optical elements. The beam profile can be selected to be non-Gaussian (i.e. flat-top profile).

Accelerators of the type rhodotron with electron energies of 40 MeV and a max. beam power of 125 kW are commercially available. The rhodotron accelerator operates at 10 up to 50 Hz with a duty cycle of 1 to 12.5%, resulting in pulse lengths of up to 2.5 ms with maximum peak current intensities of 25 mA and 3.125 mA average beam current [1b]. The electron beam can be shaped to different FWHM with the use of beam optical elements. The beam profile can be selected to be non-Gaussian (i.e. flat-top profile).

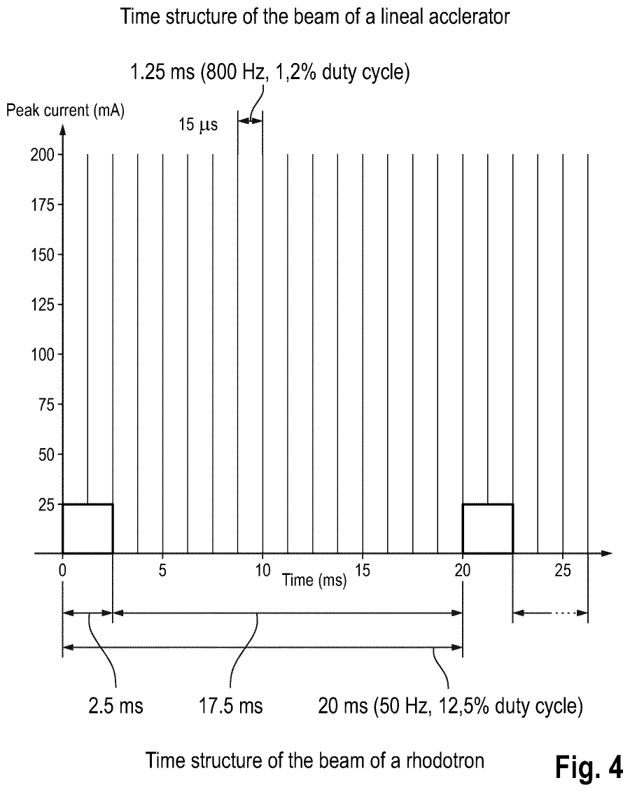

Compared to a linear accelerator, a rhodotron offers an advantage if operated in conjunction with a point source converter target. Due to the different beam structure, the beam pulses are much longer compared to a linear accelerator with about a factor of 10 reduced peak intensity. Therefore, the beam power can be spread over a larger area of quickly moving components of the vacuum window and converter assembly, thereby significantly lowering the peak temperatures induced by the passage of the intense electron beam. This situation is schematically exemplified in FIG. 4.

More specifically, FIG. 4 shows a comparison between the time structures of electron beams produced by a linear accelerator and a rhodotron. In this example the linear accelerator was assumed to produce beam pulses of 15 μs duration and 200 mA peak current at a pulse repetition rate of 800 pps. This results in an average beam current of 2.4 mA with a 1.2% duty cycle. A rhodotron is operated at 50 Hz and produces beam pulses of 2.5 ms duration at 25 mA peak current. This results in an average beam current of 3.125 mA with a 12.5% duty cycle. Due to the longer pulse duration with a lower peak current, the deposited energy in the converter can be distributed along a full rotation of the converter disk if it is rotated once within 2.5 ms (i.e. with 24,000 rpm).

In principle, linear electron accelerators can also be built superconducting, which would allow for much longer duty cycles up to 100% and very high beam currents. Therefore, the above-mentioned advantage of a long duty cycle of a rhodotron also applies for superconducting linear accelerators. The present invention of a converter target would also be applicable for a superconducting linear accelerator. However, there are currently no superconducting linear accelerators commercially available and only industrial production would lower the initial investment to commercially acceptable levels. Furthermore, superconducting accelerators need associated infrastructure for cooling to about 4.5 K, which, to some extent, counteract the advantage of lower power consumption of the accelerator.

### 3) Fast Acting Valve (Slammer Valve)

In order to protect the accelerator and the beam line from a breach of the vacuum window and the transport of materials into the accelerator cavity(-ies) a fast-acting valve is installed which is triggered by a pressure sensor located downstream of the beam line in front of the vacuum window. In case of a breach of the vacuum window, the fast-acting valve physically closes the cross-sectional area of the beam line within milliseconds before the front of the intruding shock wave reaches the accelerator.

### 4) Vacuum Window

The electron beam from the accelerator has to pass through a vacuum window that separates the vacuum of the accelerator from the cooling circuitry of the converter. This window must withstand the electron beam intensity without being compromised in its mechanical stability. Therefore, this window must consist of a material with a high melting point, good mechanical strength and of low atomic number in order to allow the passage of the electron beam with insignificant energy degradation. Furthermore, the material of the vacuum window should be chemically relatively inert and not react with components or trace components of the cooling circuitry. A suitable material for a vacuum window is a foil made from beryllium. The vacuum window and the converter target material have to be cooled, due to the energy deposited by the intense electron beam. Blackbody radiation is by far insufficient to dissipate the deposited energy.

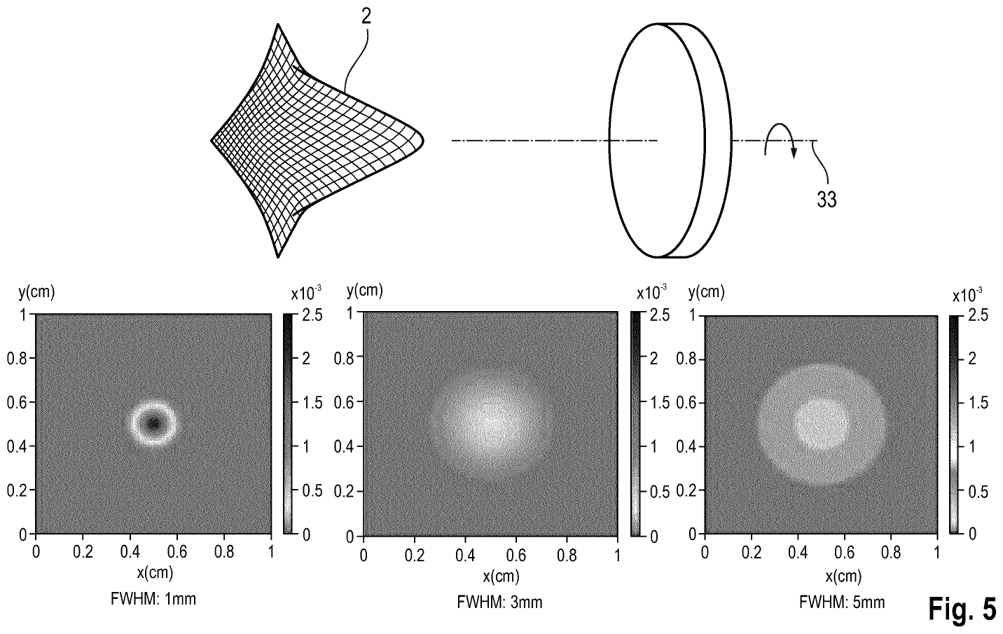

A vacuum window made from beryllium foil with thickness between 20-100 μm was considered. For these thicknesses the number of electrons losing more than 1 MeV by passage through the Be foil is less than 2%. The energy deposited in the foil is dependent on the foil thickness but does not exceed 80 Watts for a window of 100 μm thickness. The change of temperature in the center of the beam spot is heavily dependent on the FWHM of the beam. For a beam of 1 mm FWHM passing through a 20 μm thin Be window, temperature variations of about 250° C. are observed on a time constant of 50 Hz, resulting in a significant mechanical stress of the foil. As the deposited energy scales almost linearly with the vacuum window thickness, beam widths of 1 mm FWHM and 100 μm thickness lead to a breach of the vacuum window. The temperature variations can be significantly reduced by a widening of the beam profile, as illustrated in FIG. 5, however at the cost of opening the angle of the cone of high energy photons emitted by the converter target, ultimately resulting in lower flux densities at the irradiation site of the production targets.

More specifically, FIG. 5 shows the effect of the energy deposition on the Be vacuum foil as a function of FWHM of the beam. FWHM values of 1 mm, 3 mm, and 5 mm are shown.

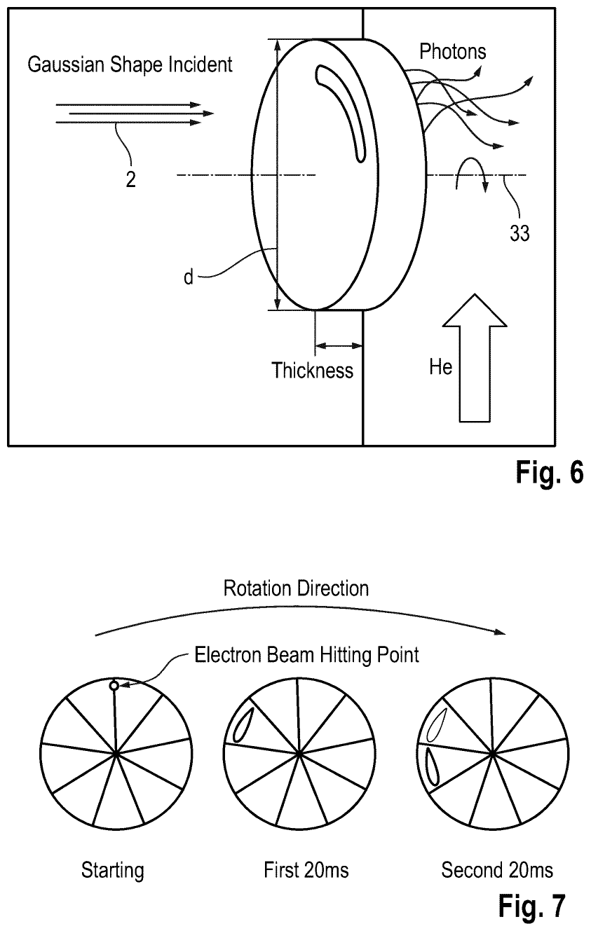

In order to further reduce temperature variations the entrance vacuum window is allowed to rotate (see FIG. 6). That is, the vacuum window is coupled to a rotary drive. By way of example, a Be foil of 4 cm diameter is mounted on a hollow shaft, which is part of a rotary vacuum feedthrough, preferably with magnetofluid sealing. Commercially available rotary vacuum feedthroughs of 4 cm can be rotated with max. speeds of about 3,100 rpm. For our considerations, the beam was hitting the periphery of the 4 cm diameter disk at a distance of 0.5 cm from the rim, resulting in an impact zone of 3 cm diameter.

More specifically, FIG. 6 shows a schematic of a Be-foil of 4 cm diameter mounted on a hollow shaft of a rotary vacuum feedthrough. One side is cooled by flowing He gas.

The rotation speed was chosen as 2,666 rpm. This way 9 segments are formed, each segment is irradiated for 2.5 ms, followed by a cooling period of 9 times 20 ms, before the same segment is irradiated again. A schematic is shown in FIG. 7. With the proposed set-up the energy deposited in the foil is distributed over a larger area of the foil, and the next beam pulse irradiates an area that had significantly more time to cool down since its last irradiation.

More specifically, FIG. 7 shows a proposed scheme of irradiation of a rotating Be foil vacuum window. The foil is rotating clockwise. With the proposed scheme of irradiation with a beam structure of 50 Hz and 12.5% duty cycle, the cooling period of the irradiated section is maximized.

The proposed set-up allows for the use of Be foils with larger thicknesses and therefore is less susceptible to a breach of the vacuum window. The maximum temperatures reached in dependence of the thickness of the Be-foil and the FWHM of the beam are displayed in FIG. 8. As can be seen, maximum temperatures are significantly reduced. Maximum temperatures of less than 130° C. are reached for window thicknesses of 100 μm and FWHM of the beam of 2 mm and larger.

More specifically, FIG. 8 shows maximum temperatures reached when a beam of electrons of 40 MeV with a beam power of 125 kW passes through a rotating vacuum window assembly in dependence of the thickness of the foil and the FWHM of the beam. The beam is deposited in a ring of 3 cm diameter, the assembly is rotating with a speed of 2,666 rpm.

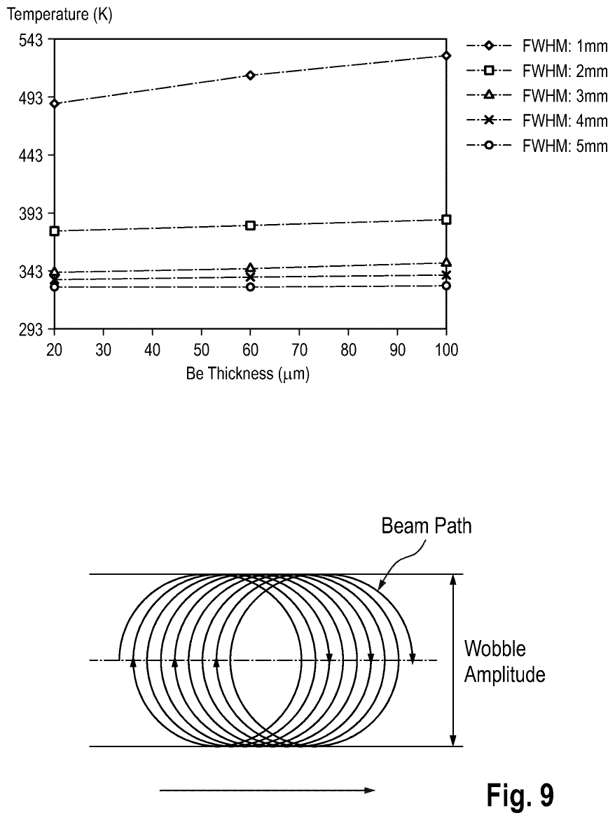

In practical experience, it is difficult to guarantee a FWHM of more than 2 mm FWHM at all times. A better focusing of the beam has the potential to destroy the vacuum window, which could induce unscheduled shut-down of the facility. Therefore, it is advantageous to install a beam wobbler system. In its simplest configuration it consists of two sets of parallel plates (beam deflectors) to which an electric field is applied. One set of parallel plates steers the beam in x-direction, while the other one steers the beam in y-direction. Applying, a sinusoidal varying voltage to both sets of plates allows to move the beam in a circular motion. This results in a more rectangular beam profile, and a deposition pattern of the beam on a moving trajectory as depicted in FIG. 9. This way, accidental focusing of the beam on the vacuum window or the converter target can be avoided, however, at the cost of a slightly larger opening angle of the emerging Bremsstrahlung cone. The circular motion of the beam can also be accomplished magnetically using a stator of an electric motor. More complex patterns known as Lissajous figures are possible, depending on the frequency of the applied voltages to the deflection plates.

### 5) Electron to Photon Converter, Housing, and Cooling

The electron beam impinges then on a converter material. The converter must be a material with a high melting point and good mechanical stability. Furthermore, the material must consist of a high atomic number and be of high density to effectively convert the electron beam to Bremsstrahlung. The high atomic number and the high density contribute to a relatively ideal point source origin of the Bremsstrahlung. For reasons of maintenance and radioactive waste management, the converter material should only marginally be activated by the electron beam. Furthermore, the material of the converter should be chemically relatively inert and not react with components or trace components of the cooling circuitry. The thickness of the converter must be adjusted to the range of the electrons in the converter material. Good converter materials are tungsten or tantalum of 4 to 5 mm thickness.

The interaction of the electrons with the converter material can be described by a multitude of physical processes and is rather complicated. For the production of radionuclides in photonuclear reactions Bremsstrahlung photons with an energy in excess of about 8 MeV are important. However, in order to consider the energy deposited in the converter material all physical processes have to be included. Of importance is the arrangement of the converter materials in relation to the target materials to be irradiated. Bremsstrahlung photons larger than 8 MeV are mainly emitted in forward direction (the beam direction) in the form of a cone with a certain opening angle.

The vacuum window and the converter target material have to be cooled, due to the energy deposited by the intense electron beam. Blackbody radiation is by far insufficient to dissipate the deposited energy. Therefore, the vacuum window and the converter have to be cooled by a liquid or gas. In our considerations we suggest a cooling by flowing helium gas. Helium has the advantage of being a material with low atomic number with high viscosity that cannot be activated or degraded by Bremsstrahlung photons.

A similar principle as applied for the construction of the vacuum window assembly can be applied to the converter target. As discussed above the converter must be a high Z, high melting point material and provide good heat conductivity. It must provide mechanical stability for fast rotation and must only be marginally activated. In our considerations we chose Tantalum as converter material for its high melting point of 3,017° C. and its machinability. Furthermore, natural tantalum consists only of 2 isotopes: ¹⁸¹Ta with a natural abundance of 99.98799% natural abundance and ^{180m}Ta with 0.01201% natural abundance. In (γ,n) or (γ, 2n) reactions on ¹⁸¹Ta will form either very ¹⁸⁰Ta or ¹⁷⁹Ta with 665 d half-live to stable ¹⁷⁹Hf, respectively. The latter nuclide decays by an electron-capture without the emission of gamma-rays. The formation of ¹⁸⁰Ta with 8.15 h half-life needs to be investigated, but its decay leads to either stable ¹⁸⁰W or stable ¹⁸⁰Hf. In (γ, pxn)-reactions on Ta stable Hf isotopes are being formed. The formation of ¹⁸²Ta from neutron-capture reactions is estimated to contribute only to a minor activation of the Ta converter material.

Also, Tungsten can be considered as a good converter material because of its high melting point of 3,422° C. Furthermore, natural tungsten consists of 5 isotopes: ¹⁸⁰W with a natural abundance of 0.12%, ¹⁸²W with 26.50% natural abundance, ¹⁸³W with 14.31% natural abundance, ¹⁸⁴W with 30.64% natural abundance and ¹⁸⁶W with 28.43% natural abundance. In (γ,n) or (γ, 2n) reactions on ¹⁸⁰W either ¹⁷⁹Ta with 665 d half-live that decays to stable ¹⁷⁹Hf, or relatively short-lived ¹⁷⁸W (T_{1/2}=22 d) that decays to ¹⁷⁸Ta is formed, respectively. In (γ,n) or (γ, 2n) reactions on ¹⁸²W and ¹⁸³W, ¹⁸¹W with a half-life of 121.2 d is formed, which decays by electron capture to stable ¹⁸¹Ta under the emission of X-rays and a very low energy gamma-ray. In (γ,n) reactions on ¹⁸⁶W, ¹⁸⁵W with a half-life of 75.1 d is formed that decay by beta-minus emission (0.4 MeV) and gamma-ray of 125 keV with low branching ratio to stable ¹⁸⁵Re. The formation of ¹⁸²Ta with 114.43 d half-life in (γ,p) or (γ, pn) reactions on ¹⁸³W and ¹⁸⁴W needs to be investigated, its dose rate may contribute significantly to the total dose rate even after an extended decay period. Of no big concern are (n, γ) reactions on the various W isotopes. In general, W has many favorable properties as converter material, but its activation is expected to be much higher than for Ta.

The converter target assembly should be very compact as to allow a high photon flux with a minimal opening angle. The ideal thickness for the formation of gamma-rays in the energy window from 8 to 30 MeV lies between 4 to 5 mm.

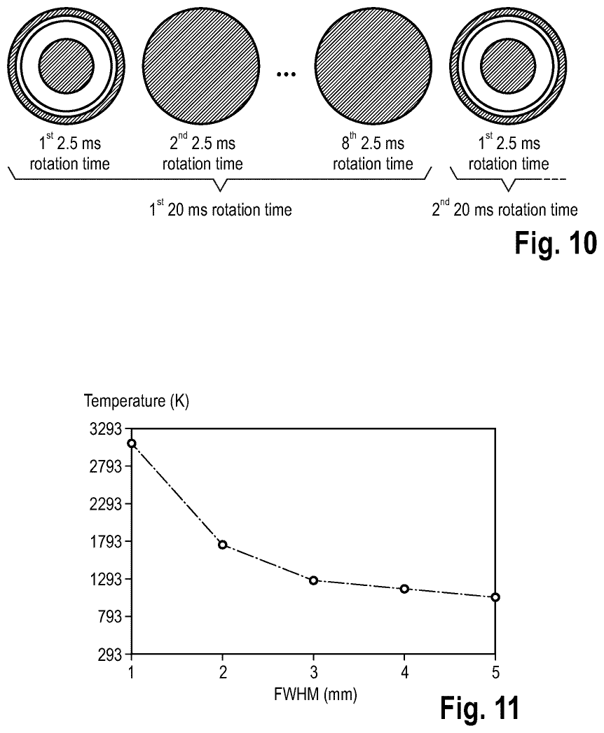

In order to distribute the energy deposition of about 45 kW (Table 1) in a 4.5 mm thick Ta converter slab, the converter target is divided into a plurality of disks, in particular 4 disks, with e.g. 1.125 mm thickness and about 18 cm in diameter. The energy of the beam pulse of 2.5 ms length is distributed around the circumference of the rotating disks assuming a diameter of 15 cm. As discussed above, the rotation speed of the disks is preferably synchronized with the time structure of the beam (in particular rotation per beam packet) which results in a rotation speed of 24,000 rpm (see FIG. 10).

More specifically, FIG. 10 shows a schematic of the distribution of the beam pulses on a rotating tantalum disk of 1.125 mm thickness.

The number of disks can be increased while adjusting the total thickness to the optimum value between 4.5 to 5 mm.

Maximum temperatures reached depend on the FWHM of the electron beam. In FIG. 11 the maximum temperatures reached in a Ta disk of 1.125 mm thickness in dependence of the FWHM of the beam are displayed. The energy deposited in the actual converter amounts to about 45 kW. To remove this heat a flow of helium gas of about 250 L/s at standard temperature and pressure (STP) is required assuming an exit temperature of the helium gas, which is 200° C. higher than the entrance temperature. This rather high flow rate of He can be provided by a commercially available medium sized pump. As can be seen in FIG. 11, the temperatures approach the melting point of Ta for a 1 mm FWHM beam, despite the fast rotation of the converter disk. However, manageable temperatures of less than 1500° C. are resulting for FWHM of the beam of larger than 2 mm. Note that for a stationary target temperatures would be in the range of 20,000 to 40,000° C. for a FWHM of the beam of 5 or 2 mm, respectively.

More specifically, FIG. 11 shows maximum temperatures reached by passage of a beam of 40 MeV electrons and 125 kW beam power through a 1.125 mm thick converter disk rotated at 24,000 rpm (deposited energy in a ring of 15 cm diameter) and cooled by rapidly flowing helium gas. Note, that for FWHM of 2 mm and more the maximum temperatures reach experimentally manageable temperatures of less than 1500° C.

The rotating converter disks and the associated flow of He cooling gas can be arranged in one of three different particularly advantageous arrangements:

### Configuration 1&2:

The converter disks are stacked on a common shaft separated by a small gap (in the order of (sub-) millimeters). The number of disks and their thickness is optimized to the electron beam energy to achieve maximal Bremsstrahlung conversion efficiency. As discussed above, the disks preferably rotate at a speed which is a multiplicative (or a fraction) of the electron beam pulse duration (e.g. 24,000 rpm for a pulse duration of 2.5 ms). The disks are tightly enclosed in a water-cooled housing with a small gap between disk and wall. To cool the disks, which are heated by the particle beam as described above, a cooling gas (e.g. Helium) is circulated through the gaps in between the disks. Co-centric to the shaft, orifices are foreseen to facilitate axial gas flow along the shaft. The housing incorporates openings to allow gas circulation to or from the outer edge of the disks. This configuration describes a cohesion-type turbine/pump, also called Tesla turbine/pump, as originally described in U.S. Pat. No. 1,061,206, hereby incorporated by reference.

The gas flow in between the disks described a spiraling flow (vortex) due to the interplay of the gas, its adhesion to the disks and internal viscosity. In the turbine configuration the pressure difference at the inlet and outlet drive the rotation of the disks due to wall friction, here the gas flows from the periphery of the disk towards the center. Due to the induced fast rotation, the contact time of the gas with the surfaces of the disks is prolonged and the heat transfer to the cooling gas optimized. In pump configuration, the shaft is externally driven, and the gas flow is inverted, flowing from the shaft towards the outer rim of the disks.

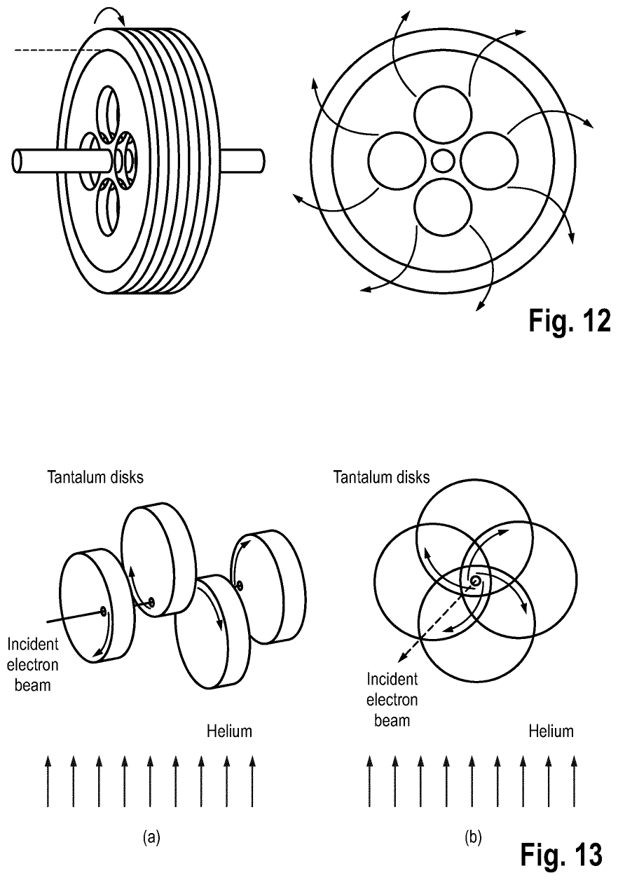

For both flow patterns, the predominantly radial flow of the cooling gas enables homogenous cooling of the disks. Furthermore, with an increase of the number of disks, comes an increase in the total surface area available for cooling. Although the total heat load of the system in this configuration will be comparable to the above presented numbers, approximately 45 kW of absorbed power in the converter material (see Table 1), but the load per disk can be lowered. FIG. 12 shows an illustration of the design in turbine (left) and pump (right) configuration (housing not shown).

More specifically, FIG. 12 shows an illustration of the Tesla converter design. On the left the full disk assembly is shown in turbine configuration with a shaft and multiple disks, the particle beam (in blue) impinges on the disk near the outer edge (the heated area, corresponding to the circular trace of the electron beam is indicated). On the right, a sketch of the cooling gas flow pattern on a single disk is depicted for a converter in pump configuration. The direction of the flow pattern is reversed in turbine configuration.

### Configuration 3:

In this configuration, the disks are arranged in the form of partially overlapping circles as displayed in FIG. 13. This way some of the energy can be dissipated by black body radiation to the walls of the container vessel and exposition of a large area to the rapidly flowing cooling gas is achieved. The disks are externally driven and all rotate either clockwise or counterclockwise in the same direction at a speed which preferably is a multiplicative (or a fraction) of the electron beam pulse duration, as discussed above (e.g. 24,000 rpm for a pulse duration of 2.5 ms).

More specifically FIG. 13 shows an arrangement of four (e.g. Ta) disks as converter targets. The disks are 1.125 mm thick spaced at a distance of 1 mm between the disks (left). In the right section a view in electron beam direction is given. The disks are rotating at 24,000 rpm and are externally driven. A flow of He is used to cool the arrangement.

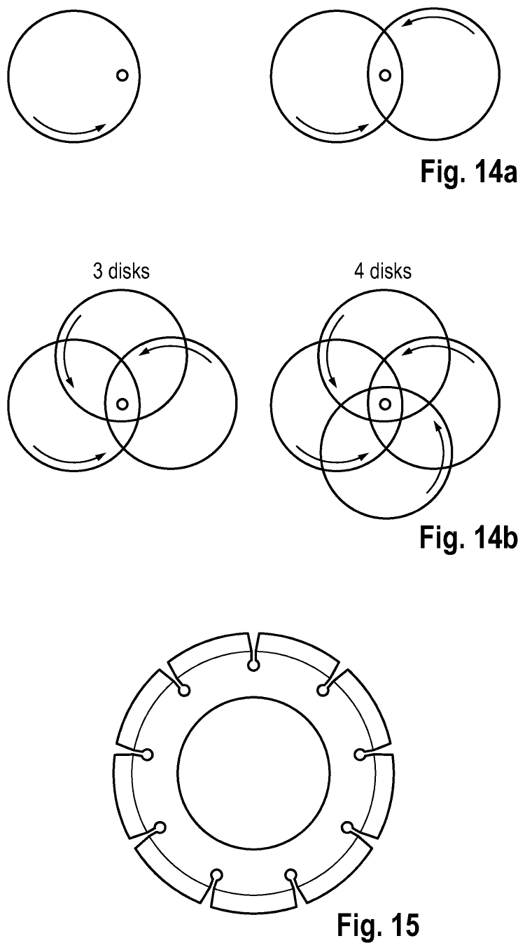

In principle, the number of disks can also be reduced as exemplified in FIG. 14a.

FIG. 14b shows an arrangement of converter disks, that allow mounting of the disks on an axis with two bearings.

In order to prevent warping of the disks due to thermal expansion, slotted disks can be used as they are used in cutting wheels or brake rotor disks as illustrated as an example in FIG. 15. If several disks are employed as shown in FIG. 13, the disks can be staggered, in order to guarantee total absorption of the electron beam (no overlapping of slots).

### 6) Flattening Filter and Neutron Absorber

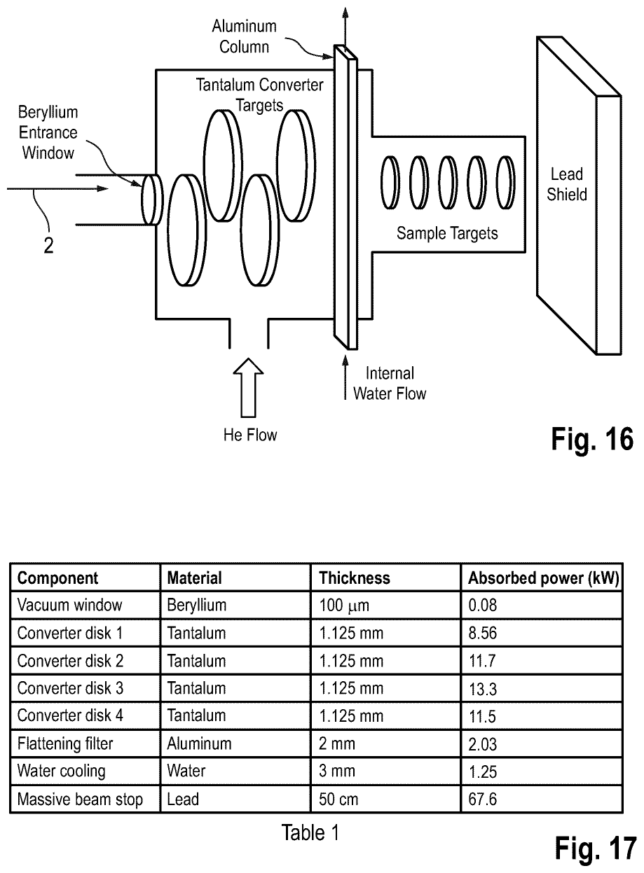

The exit window of the converter target assembly can be made either from beryllium foil or constructed as a flattening filter in order to protect the targets from irradiation with electrons, X-rays, and low energy gamma-rays. The flattening filter is made from a rectangular aluminum profile with e.g. 1 mm wall thickness (see FIG. 16). The inside of the profile realized a channel, which is flushed with a cooling fluid, in particular cooling water of e.g. 3 mm thickness. The task of this unit is to filter out and therefore considerably reduce the flux of low energy photons that are not contributing to photonuclear reactions. The reduction of the number of electrons compared to the number of source electrons by introduction of a flattening filter amounts to 20.8%, with the largest reduction of in the energy region from 0-8 MeV of 11.2%.

In the irradiation of the converter material with high-energetic electrons, also photoneutrons are generated in (γ, xn)-photonuclear reactions. These neutrons may induce undesired neutron capture reactions in the production targets and lead to undesired by-products, diminishing the radionuclidic purity of the product. One such example is the production of long-lived ²²⁷Ac (T_{1/2}=21.773 a) in (n,γ)-reactions on ²²⁶Ra. The ²²⁷Ac byproduct causes serious waste and radioprotection issues and, depending on its activity percentage compared with ²²⁵Ac, may render the product unusable. As neutron absorbers, different materials such as gadolinium, cadmium or boron or combinations thereof can be employed.

More specifically, in FIG. 16 the position of a water-cooled aluminum column is shown which serves as exit window and flattening filter to prevent the irradiation of the sample targets with electrons and low energy photons.

While FIG. 16 shows a converter target of the overlapping disks type known from FIG. 13, this is just an example. Naturally, the above-described cooling provisions and the beam stop of FIG. 16 can be combined with other converter types as well.

### 7) Production Target(s)

Target materials must be placed in the emerging cone of photons to be effectively irradiated. If the amount of target material is limited (i.e. ²²⁶Ra, or isotopically highly enriched materials such as, but not limited to ⁴⁸Ca, ⁴⁸Ti, ⁶⁸Zn, ¹⁰⁰Mo, ¹¹²Sn, or ¹⁵⁰Nd, the target needs to be placed as close as possible to the converter. Due to the close geometrical arrangement of the converter, a high as possible photon flux density is achieved. The production of ⁹⁹Mo from ¹⁰⁰Mo in a (γ,n)-reaction results in a “carrier added” ⁹⁹Mo that cannot be chemically separated from the target material ¹⁰⁰Mo. In order to produce easy to use ^{99m}Tc radionuclide generators from this material, the specific activity of the ⁹⁹Mo should exceed about 5 Ci/g of Mo. This can only be accomplished by irradiations of highly enriched ¹⁰⁰Mo with a high photon flux density, where the photons emerge from a point like converter source. Since photons of 8 MeV or higher energies are very penetrating, a stack of target materials can be irradiated simultaneously. During irradiation, the target materials absorb photons and energy is deposited in the targets. Therefore, the targets have to be cooled, e.g. by flowing cooling water. The high photon energies have the advantage that target materials, which are difficult to handle i.e. because of their radioactivity, toxicity, or chemical reactivity can safely be encapsulated in suitable materials for irradiation. Therefore, a breach of target materials into the cooling water circuit can be avoided. Furthermore, the simultaneous irradiation of multiple production targets with the same photon beam is possible, allowing the simultaneous production of several radionuclides. As an example, the relatively thin ²²⁶Ra would be loaded in the positions closest to the converter assembly, where the photon flux is highest, followed by targets of e.g. ¹¹²Sn or ¹⁵⁰Nd, which allow high production rates, but are relatively expensive as enriched materials, followed by massive targets of ⁶⁸Zn or ⁴⁸Ti, where chemical separation and reclamation procedures already exist in dealing with the large amounts of target material. Preferably, provisions to remotely load, unload and transport the targets to the processing hot-cells are made.

### 8) Massive Beam Stop

Since most of the high energy photons will penetrate all target materials, they must be stopped by a massive, preferably water-cooled beam stop made from i.e. lead. According to Table 1, the energy deposited in the beam stop amounts to about 68 kW. For reasons of shielding, a vertical arrangement of electron beam, converter and production targets could be envisaged, using the ground as additional shielding around the massive beam stop. Otherwise, additional shielding (i.e. concrete) must be put in place to reduce the gamma-ray dose to acceptable levels.

Inside the massive beam stop, provisions to irradiate artificial gemstones can be foreseen. The high energy gamma radiation is inducing defects in the lattice of artificially produced gemstones that act as color centers and thereby allow permanent coloring of artificially produced gemstones such as topaz.

### 9) Cooling Circuitry

Preferably, as cooling medium helium gas has been chosen due to its low atomic number and density, its chemical inertness and its reasonable heat capacity. Furthermore, He is not reacting with the high energy Bremsstrahlung photons. Assuming a temperature increase of 200° C., about 250 L/s of He at STP are required to remove the energy deposited in the converter target assembly. The helium gas is foreseen to enter the converter assembly at room temperature. The helium gas is preferably circulated in a gas loop. Therefore, the cooling circuitry preferably comprises a high flow pump, high flow heat exchangers, a reservoir tank, filters for trace components such as oxygen, water vapor and particles, and for provisions to fill and empty the circuitry with helium gas. The pressure in the He tank (high pressure side) can be adjusted by a butterfly valve connected to pressure sensors. Several components of the cooling circuit can be sourced from the automotive industry, such as high-flow interchillers or radial compressors. Chillers, that are able to remove heat of the order of 100 kW or more are available in air conditioning units of buildings.

### Calculated Yields of Radionuclides (Examples):

With the point source high power converter target assembly as described above and the arrangement of production targets as displayed in schematic FIG. 16, the following yields can be obtained, assuming an electron energy of 40 MeV and 125 kW of beam power:

Production of ²²⁵Ra from ²²⁶Ra:

With a target thickness of 100 mg/cm² and a target diameter of 2 cm in position 1 of the target assembly the production of 10.65 GBq ²²⁵Ra/day of irradiation were calculated. This corresponds to about 5 GBq of ²²⁵Ac after an ingrowth period of 14 to 15 days. In order to limit the number of chemical separation procedures, it is advantageous to select longer irradiation times, for example 2 weeks. After few days waiting time a first batch of ²²⁵Ac can be separated from the irradiated target. From thereon, with an optimum waiting time of about 17 days, so-called 2^{nd} and 3^{rd} chance ²²⁵Ac can be separated from the irradiated target due to the ingrowth of ²²⁵Ac from decay of ²²⁵Ra with a half-life of 14.9 d. Assuming such a production regime and a patient dose of 10 MBq about 500 patient doses can be produced per day from one ²²⁶Ra target.

Production of ⁹⁹Mo from ¹⁰⁰Mo:

With a target thickness of 1 g/cm² and a target diameter of 2 cm in position 1 of the target assembly the production of about 650 GBq ⁹⁹Mo/day of irradiation were calculated. This corresponds to about 17.5 Ci/day/target. With 1 g/cm² the target thickness is still relatively thin.

The calculated yields show that photonuclear reactions are a viable production method for medical radionuclides. The above-described point source high power converter target assembly is capable of absorbing enormous beam powers of up to 125 kW and make routine radionuclide production with the use of an electron accelerator of the rhodotron type possible.

### REFERENCES

The following reference are hereby incorporated by reference:
[1a] MEVEX The accelerator technology company. High Power Linacs for Isotope Production. http://www.mevex.com/Brochures/Brochure_High_Energy.pdf [accessed May 17, 2019]
[1b] Ion Beam Applications, IBA Industrial, Rhodotron® TT300-HE High Energy Electron Generator, www.iba-industrial.com [accessed Jun. 26, 2018]

### LIST OF REFERENCE NUMERALS

1 electron beam source (electron accelerator)
2 electron beam
3 electron beam transfer line (vacuum pipe)
4 vacuum valve (slammer valve)
5a-c beam optical elements (quadrupole triplet)
6, 7 beam deflection units (vertical and horizontal steering magnet)
8 entry window holder for a vacuum window
9 housing
10 cooling medium ports (inlet and outlet port)
11 cooling loop (cooling circuit)
12 converter disk
13 rotation axis
14 projected focal beam spot (trace in time)
15 cone of Bremsstrahlung photons (photon field)
16 neutron absorber
17 production target
18 beam stop
19 cavity
20 converter target
21 converter target assembly
22 flattening filter/exit window
23 vacuum window disk
24 vacuum window control unit
25 converter disk control unit
26 vacuum window rotary drive
27 converter disk rotary drive
30 hollow shaft
31 magnetofluid seal
32 bearings
33 rotational axis

1. A facility for the production of radionuclides, in particular diagnostic and therapeutic radionuclides, based on the principle of photonuclear irradiation, comprising:
an electron accelerator, producing an electron beam,
a converter target assembly with a converter target that converts the electron beam to Bremsstrahlung photons,
a number of production targets, irradiated by the Bremsstrahlung photons and thereby producing said radionuclides,
wherein the converter target assembly comprises a sealed housing, the housing
enclosing a cavity which holds the converter target,
comprising an entry window with a window disk for the electron beam and an exit window for the Bremsstrahlung photons,
comprising cooling medium ports, these ports being part of a cooling circuit for establishing a cooling flow through the cavity, thereby cooling the converter target and the window disk,
wherein
the converter target comprises a number of rotatable converter disks,
the electron beam is set off-center with respect to a respective converter disk of the rotatable converter disks,
and wherein the respective converter disk is designed to rotate during operation of the facility, thereby, in the course of time, spreading the focal spot of the electron beam over an annular area of the respective converter disk.

2. The facility according to claim 1, wherein the electron accelerator generates a pulsed or a continuous wave electron beam, wherein the pulsed or the continuous wave electron beam has impulse times and period times in the range of milliseconds or longer.

3. The facility according to claim 1, wherein the electron beam is a pulsed electron beam, and further comprising a control unit which keeps the rotation speed of the respective converter disk synchronized with a time structure of the electron beam pulses.

4. The facility according to claim 3, wherein the annular area on the respective converter disk exposed to a single beam pulse describes a complete ring or sectors thereof, wherein the ratio of a revolution time of the respective converter disk to beam pulse time is preferably chosen such that all sectors are irradiated homogeneously over multiple irradiation cycles.

5. The facility according to claim 1, wherein a rotation speed of the respective converter disk is set in the range from a few thousands to several ten thousands of revolutions per minute.

6. The facility according to claim 1, wherein the window disk is rotatable and held or supported by an entry window holder, the electron beam is set off-center with respect to the window disk, and wherein the window disk is configured to rotate during operation of the facility at a rotation speed, thereby, in the course of time, spreading the focal spot of the electron beam over an annular area of the window disk.

7. The facility according to claim 6, wherein the entry window holder comprises or holds a circular window disk, which is a Beryllium foil or high strength material with low atomic number, wherein the entry window holder is coupled to a hollow shaft, which is part of a rotary vacuum feedthrough.

8. The facility according to claim 7, wherein the entry window holder and the window disk or the rotary vacuum feedthrough are sealed with respect to a beam transfer line by a magnetofluid sealing.

9. The facility claim 6, wherein a control unit keeps the rotation speed of the entry window holder and the mounted window disk synchronized with the time structure of the electron beam pulses.

10. The facility according to claim 9, wherein an area on the window disk exposed to a single beam pulse describes a complete ring or sectors thereof, wherein a ratio of the revolution time of the window disk to the beam pulse time is preferably chosen such that all sectors are irradiated homogeneously over multiple irradiation cycles.

11. The facility claim 6, wherein the rotation speed of the window disk is set in the range from several hundreds to several thousands of revolutions per minute.

12. The facility according to claim 1, wherein a beam transfer line comprises an optical element that allows for focusing or defocusing of the electron beam to different FWHM and, wherein a FWHM of at least 2 mm is set.

13. The facility according to claim 1, wherein the converter target comprises four converter disks.

14. The facility according to claim 13, wherein the converter disks are stacked on a common shaft.

15. The facility according to claim 13, wherein the converter disks are arranged on parallel shafts, such that the converter disks partially overlap when viewed in the direction of the shafts, wherein each shaft is aligned in parallel to the direction of the electron beam.

16. The facility according to claim 1, wherein the respective converter disk is coupled to a rotary drive.

17. The facility according to claim 1, wherein the converter disk comprise multiple converter disks arranged to form a Tesla pump.

18. The facility according to claim 1, wherein the converter disks are configured to be driven by a cooling flow.

19. The facility according to claim 18, wherein the converter disks comprise multiple converter disks arranged to form a Tesla turbine.

20. The facility according to claim 1, further comprising a cooling medium, wherein the cooling medium is a cooling gas.

21. The facility according to claim 1, wherein a region of origin of emerging Bremsstrahlung photons, apart from some optional wobbling with an amplitude in the range of millimeters, is fixed in space.

22. A converter target assembly for a facility, comprising a sealed housing, the housing
enclosing a cavity which holds a converter target,
the housing further comprising an entry window holder with a mounted entry window disk for an electron beam and an exit window for Bremsstrahlung photons,
the housing further comprising cooling medium ports, the ports being designated to be connected to a cooling circuit for establishing a cooling flow through the cavity, thereby cooling the converter target and the entry window holder with its mounted entry window disk,
wherein the converter target comprises a number of rotatable converter disks, and wherein a converter disk of the rotatable converter disks is designed to rotate during operation of the facility, thereby, in the course of time, spreading the focal spot of an incoming electron beam over an annular area of the converter disk.

23. A converter target assembly according claim 22, wherein the entry window holder comprises a rotatable window disk, wherein the window disk is configured to rotate during operation of the facility, thereby, in the course of time, spreading the focal spot of an incoming electron beam over an annular area of the window disk.

24. A method of producing radionuclides, comprising:
directing an electron beam onto a converter target with a number of rotating converter disks, such that, in the course of time, a focal spot of the electron beam is spread over an annular area of a converter disk, thereby producing a beam of Bremsstrahlung photons for irradiation of a production target, and cooling the converter target by a flow of cooling medium, wherein the cooling medium is gaseous Helium.

25. The method of claim 24, wherein the converter target is arranged inside a housing, and wherein the electron beam is lead through a rotating entry window holder with a mounted entry window disk of the housing, such that, in the course of time, the focal spot of the electron beam is spread over an annular area of the entry window disk.
